(19) United States
(12) Patent Application Publication
(10) Pub. No.: US 2021/0376600 A1
(43) Pub. Date: Dec. 2, 2021

(54) Transient Voltage Protection for Low Voltage Circuits

(71) Applicant: LOON LLC, Mountain View, CA (US)

(72) Inventors: Matthew Torres, Sunnyvale, CA (US); Jared Bevis, San Mateo, CA (US)

(73) Assignee: LOON LLC, Mountain View, CA (US)

(21) Appl. No.: 16/888,400

(22) Filed: May 29, 2020

(51) Int. Cl. H02H 9/04

(52) U.S. Cl. CPC H02H 9/046; H04B 7/18502

(57) ABSTRACT

The technology relates to techniques for transient voltage protection for low voltage circuits. A transient voltage protection circuit can include an input, wherein a transient voltage event causes a transient voltage at the input; a transient voltage suppression (TVS) diode implemented downstream from the input, wherein the TVS diode is configured to absorb energy of the transient voltage event; and a metal-oxide-semiconductor field-effect transistor (MOSFET) implemented downstream from the TVS diode; wherein: a gate voltage applied to the MOSFET is based on a desired on-state resistance of the MOSFET in the absence of the transient voltage; energy of the transient voltage event that is not absorbed by the TVS diode and that is transmitted past the TVS diode enters a drain of the MOSFET; and the MOSFET is configured to clamp in a linear mode in response to the transient voltage event.

### BACKGROUND OF INVENTION

Electronic circuits containing components with low operating voltages (e.g., less than about 5 V) are often susceptible to damage by voltage transient events. A voltage transient event causes a short duration surge of electrical energy to enter a circuit, which can damage sensitive components of the circuit. The energy surge can result from energy previously stored in the circuit or induced from outside the circuit. The energy surge from a transient event can be predictable, for example when caused by controlled switches, or can be random, for example when caused by external sources. Systems containing components such as motors, generators, or the switching of reactive circuit components often suffer from repeatable voltage transient events, while external sources such as lightning and electrostatic discharge (ESD) can cause random voltage transient events.

In circuits where transient voltage events are an issue, a conventional solution is to implement a transient voltage suppression (TVS) diode to absorb the transient energy and protect sensitive elements of the circuit. In such examples, the TVS diode is placed on an external interface of a circuit node containing the sensitive components. Two important parameters in a TVS diode are the reverse standoff voltage and the maximum clamping voltage. The reverse standoff voltage is the maximum reverse bias voltage that can be applied to the TVS diode while maintaining low leakage current, so the reverse standoff voltage is typically designed to be close to, but slightly greater than, a signal voltage (i.e., a voltage the circuit will utilize during routine operation in the absence of a transient voltage event). In conventional transient protection circuits, the maximum clamping voltage of the TVS diode is the maximum voltage that the node being protected by the TVS diode will see in a transient event. Unfortunately, the clamping voltage is always higher than the reverse standoff voltage. This means that during a transient event, the node itself must be able to survive a voltage equal or greater to the maximum clamping voltage. Therefore, the TVS diode must be able to withstand the voltage spike during a transient event and also have a maximum clamping voltage below a value that would damage downstream components. Therefore, in conventional transient protection circuits, the system is often over-determined and a compromise must be made, such as to employ a resistor capacitor (RC) low pass filter after the TVS diode to slow the transient into the downstream circuits. However, such a filter also limits the bandwidth of the signal during routine operation (i.e., in the absence of a voltage transient event).

Conventional transient protection circuits employing TVS diodes can effectively protect components in some systems, such as some types of microprocessors, metal-oxide-semiconductor (MOS) memory, AC/DC power lines, data/signal input and/or output lines (e.g., for serial communication or ethernet), and telecommunication equipment, because these systems are exposed to transients that can be accommodated by a TVS diode and the circuit components being protected can withstand the maximum clamping voltage of the TVS diode.

### BRIEF SUMMARY

The present disclosure provides techniques for transient voltage protection for low voltage circuits. A transient voltage protection circuit can include an input, wherein a transient voltage event causes a transient voltage at the input; a transient voltage suppression (TVS) diode implemented downstream from the input, wherein the TVS diode is configured to absorb energy of the transient voltage event; and a metal-oxide-semiconductor field-effect transistor (MOSFET) implemented downstream from the TVS diode; wherein: a gate voltage applied to the MOSFET is based on a desired on-state resistance of the MOSFET in the absence of the transient voltage; energy of the transient voltage event that is not absorbed by the TVS diode and that is transmitted past the TVS diode enters a drain of the MOSFET; and the MOSFET is configured to clamp in a linear mode in response to the transient voltage event. In an example, a positive signal voltage is applied at the input, wherein the transient voltage is larger than a maximum positive signal voltage; the metal-oxide-semiconductor field-effect transistor (MOSFET) is an N-channel MOSFET; and the gate voltage is the sum of the maximum positive signal voltage and a gate-to-source threshold voltage of the N-channel MOSFET. In another example, a negative signal voltage is applied at the input, wherein the transient voltage is smaller than a minimum negative signal voltage; the metal-oxide-semiconductor field-effect transistor (MOSFET) is a P-channel MOSFET; and the gate voltage is the minimum negative signal voltage minus a gate-to-source threshold voltage of the P-channel MOSFET. In another example, the transient voltage protection circuit also includes a resistor located between the transient voltage suppression diode and the metal-oxide-semiconductor field-effect transistor (MOSFET). In another example, the transient voltage protection circuit also includes a capacitor connected to the gate of the metal-oxide-semiconductor field-effect transistor (MOSFET) to counteract a drain-gate parasitic capacitance of the MOSFET. In another example, the transient voltage protection circuit also includes a low voltage node downstream from the metal-oxide-semiconductor field-effect transistor (MOSFET), wherein a component of the low voltage node is susceptible to failure if exposed to a maximum clamping voltage of the transient voltage suppression diode. In another example, the low voltage node includes a low voltage component selected from the group consisting of an amplifier, an analog to digital converter, a digital to analog converter, a component in an analog front end of a circuit board, a digital logic component, a resistive temperature device, or a sensor. In another example, a voltage transmitted to the low voltage node is below a critical voltage level. In another example, the low voltage node is susceptible to failure if a voltage greater than 3.6 V is applied to the low voltage node. In another example, the transient voltage protection circuit also includes a charge pump circuit, a voltage boost circuit, an isolated power supply, an alternate power rail, or an attenuated power rail, that is used to apply the gate voltage. In another example, the gate voltage applied to the metal-oxide-semiconductor field-effect transistor (MOSFET) is further based on a temperature profile of the MOSFET. In another example, the transient voltage event is caused by lightning or electrostatic discharge. In another example, an aerial vehicle contains the transient voltage protection circuit. In another example, the transient voltage protection circuit also includes a low voltage node including a component of an aerial vehicle.

A transient voltage protection circuit can include an input, wherein a transient voltage event causes a transient voltage at the input; a transient voltage suppression (TVS) diode implemented downstream from the input, wherein the TVS diode is configured to absorb energy in the transient voltage event; a first metal-oxide-semiconductor field-effect transistor (MOSFET) implemented downstream from the TVS diode, wherein: a first gate voltage applied to the first MOSFET is based on a desired on-state resistance of the first MOSFET in the absence of the transient voltage; and energy of the transient voltage event that is not absorbed by the TVS diode and that is transmitted past the TVS diode enters a drain of the first MOSFET; and a second MOSFET implemented downstream from the first MOSFET, wherein: a second gate voltage applied to the second MOSFET is based on a desired on-state resistance of the second MOSFET in the absence of the transient voltage; and energy of the transient voltage event that is not absorbed by the TVS diode or by the first MOSFET and that is transmitted past the first MOSFET enters a drain of the second MOSFET. In an example, the first metal-oxide-semiconductor field-effect transistor (MOSFET) is an N-channel MOSFET configured to clamp in a linear mode in response to a positive transient voltage; and the second MOSFET is a P-channel MOSFET configured to clamp in a linear mode in response to a negative transient voltage. In another example, the transient voltage is larger than a maximum positive signal voltage; and when a positive signal voltage is applied at the input, the first gate voltage is the sum of the maximum positive signal voltage and a first gate-to-source threshold voltage of the first metal-oxide-semiconductor field-effect transistor (MOSFET). In another example, the first metal-oxide-semiconductor field-effect transistor (MOSFET) is a P-channel MOSFET configured to clamp in a linear mode in response to a negative transient voltage; and the second MOSFET is an N-channel MOSFET configured to clamp in a linear mode in response to a positive transient voltage. In another example, the transient voltage is smaller than a minimum negative signal voltage; and the first gate voltage is the minimum negative signal voltage minus a first gate-to-source threshold voltage of the first metal-oxide-semiconductor field-effect transistor (MOSFET). In another example, the transient voltage protection circuit also includes a resistor placed between the transient voltage suppression diode and the first metal-oxide-semiconductor field-effect transistor (MOSFET). In another example, the transient voltage protection circuit also includes a first capacitor connected to a gate of the first metal-oxide-semiconductor field-effect transistor (MOSFET) to counteract a first drain-gate parasitic capacitance of the first MOSFET; and a second capacitor connected to a gate of the second MOSFET to counteract a second drain-gate parasitic capacitance of the second MOSFET. In another example, the transient voltage protection circuit also includes a low voltage node downstream from the second metal-oxide-semiconductor field-effect transistor (MOSFET), wherein the low voltage node is susceptible to failure if exposed to a maximum clamping voltage of the transient voltage suppression diode. In another example, the low voltage node comprises a low voltage component selected from the group consisting of a n amplifier, an analog to digital converter, a digital to analog converter, a component in an analog front end of a circuit board, a digital logic component, a resistive temperature device, or a sensor. In another example, a voltage transmitted to the low voltage node is below a critical voltage level. In another example, the low voltage node is susceptible to failure if a voltage greater than 3.6 V is applied to the low voltage node. In another example, the transient voltage protection circuit also includes a charge pump circuit, a voltage boost circuit, an isolated power supply, an alternate power rail, or an attenuated power rail, that is used to apply the first gate voltage and the second gate voltage. In another example, the first gate voltage applied to the first metal-oxide-semiconductor field-effect transistor (MOSFET) is further based on a temperature profile of the first MOSFET; and the second gate voltage applied to the second MOSFET is further based on a temperature profile of the second MOSFET. In another example, the transient voltage event is caused by lightning or electrostatic discharge. In another example, an aerial vehicle contains the transient voltage protection circuit. In another example, the transient voltage protection circuit also includes a low voltage node including a component of an aerial vehicle.

### BRIEF DESCRIPTION OF THE DRAWINGS

FIGS. 1 and 2 are simplified schematic diagrams depicting examples of transient voltage protection circuits, in accordance with some embodiments.

FIG. 3 is a circuit diagram showing an example of a transient voltage protection circuit with a positive signal voltage and an N-channel metal-oxide-semiconductor field-effect transistor (MOSFET), in accordance with some embodiments.

FIG. 4 is a circuit diagram showing an example of a transient voltage protection circuit with a negative signal voltage and a P-channel MOSFET, in accordance with some embodiments.

FIG. 5 is a circuit diagram showing an example of a transient voltage protection circuit utilizing two MOSFETs configured in series, in accordance with some embodiments.

FIGS. 6A-6B are diagrams of example unmanned aerial vehicle (UAV) systems incorporating the present transient voltage protection circuits, in accordance with some embodiments.

FIG. 7 shows a simplified schematic of an UAV incorporating the present transient voltage protection circuits, in accordance with some embodiments.

FIG. 8 shows a simplified schematic of an example of an environmental monitoring system incorporating the present transient voltage protection circuits, in accordance with some embodiments.

FIGS. 9 and 10 are flowcharts for methods of protecting low voltage components from transient voltage events.

The figures depict various example embodiments of the present disclosure for purposes of illustration only. One of ordinary skill in the art will readily recognize from the following discussion that other example embodiments based on alternative structures and methods may be implemented without departing from the principles of this disclosure, and which are encompassed within the scope of this disclosure.

### DETAILED DESCRIPTION

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The present invention is directed to transient voltage protection for low voltage circuits using a transient voltage suppression (TVS) element (e.g., a TVS diode) in serial with a transistor, such as an N-channel metal-oxide-semiconductor field-effect transistor (MOSFET), a P-channel MOSFET, or another type of field-effect transistor (FET). In some cases, both an N-channel and a P-channel MOSFET can be used in serial with a bidirectional TVS diode. Many low voltage level circuits or nodes have a small range of operating voltages (e.g., with magnitudes less than 5 V, or from 0 V to 2.5 V), and such nodes cannot survive exposure to transient voltage events (e.g., lightning transients, electrostatic discharge (ESD), or other large injected or induced potentials). In some embodiments, a TVS diode is configured to absorb primary energy from a transient event (e.g., a majority of the surge energy caused by a transient event) and protect a node from experiencing voltage levels equal to or beyond the maximum clamping voltage of the TVS diode. In some embodiments, a MOSFET implemented downstream from the TVS diode is configured to clamp itself in a linear mode (e.g., a high resistance mode) during said transient event, to further protect the node from experiencing high voltages due to the transient event. In such cases, the TVS diode and MOSFET are chosen such that there is a minimum filter effect on the circuit during routine operation (i.e., in the absence of a voltage transient event), compared to conventional transient protection circuits (e.g., those using low pass filters).

A TVS diode is often used on an external interface of a node in a conventional circuit to protect the node from transient voltage events. However, a standard TVS diode will have a maximum clamping voltage (i.e., the maximum voltage that will be transmitted past the TVS diode in a transient event) higher than its reverse standoff voltage (i.e., a voltage that is typically close to a routine signal voltage), the node itself must withstand a voltage at least equal to the maximum clamping voltage during a transient voltage event. Additionally, the TVS diode must be able to withstand the voltage spike during a transient event. A TVS diode with a high power rating is required for large voltage transients (e.g., those causing voltage spikes on the order of tens of kV, hundreds of kV, and even larger), and such TVS diodes also have larger maximum clamping voltages than TVS diodes that can withstand smaller voltage transients. Therefore, many low voltage level circuits that are exposed to large voltage transient events (e.g., lightning strikes or ESD) cannot withstand the relatively high maximum clamping voltage of TVS diodes that are rated high enough to withstand the voltage transient, and as a result a TVS diode alone cannot protect low voltage level circuits from large transient voltage events.

The current systems and methods utilize a MOSFET in conjunction with a TVS diode (or other primary transient protection such as a metal oxide varistor, an avalanche diode (e.g., a Zener diode), a spark gap, or a gas discharge tube) to block a voltage transient. A voltage transient can cause a medium to large voltage (e.g., greater than 10 kV, greater than 100 kV) to be applied to a circuit during a voltage transient event over a short time period (e.g., tens of microseconds), or a smaller voltage (e.g., greater than 10 V, or on the order of tens of volts). The present circuits are advantageous for protecting low voltage circuits from voltage transients (e.g., medium to large voltage transients, or smaller voltage transients) since the TVS diode absorbs the primary energy from the transient and the MOSFET further reduces the voltage below the maximum clamping voltage of the TVS diode to provide adequate protection for low voltage circuit components. In the present systems, the TVS diode absorbs most of the energy from a voltage transient event and the MOSFET absorbs additional energy (i.e., that is transmitted past the TVS diode) thereby preventing the downstream (e.g., source) node from seeing an oversized spike in voltage during the transient event.

In the present systems, a gate voltage is applied to the MOSFET downstream from the TVS diode such that the MOSFET is normally in a low resistance on-state. The gate voltage can be chosen based on the desired on-state resistance of the MOSFET and an operating temperature, or temperature profile, of the MOSFET. This is beneficial because the MOSFET resistance and the gate-to-source threshold voltage will both typically change over the operating temperature range (e.g., the resistance can increase with temperature and the gate-to-source threshold voltage can decrease with temperature), and as the neighboring TVS element and the MOSFET absorbs energy from the transient event the temperature of the MOSFET will increase. The MOSFET is selected and the gate voltage is chosen such that the MOSFET will clamp itself in a linear mode when a voltage transient occurs. When the MOSFET clamps itself in a linear high resistance mode, it will absorb additional energy from the transient and the voltage at the output of the MOSFET (e.g., at the source terminal of the MOSFET) can be kept below the maximum operating voltages of the sensitive low voltage components downstream from the TVS diode and the MOSFET. As a result, the node containing sensitive components is sufficiently protected from the external transient.

There are many types of circuit components that have low operating voltages, which are susceptible to damage when exposed to the maximum clamping voltage of a high power TVS diode (i.e., one able to withstand large voltage transient events) during a high voltage transient. Some examples of low voltage circuit components are typical components in an analog front end of a circuit board, sensors (e.g., thermometers and resistance temperature detectors, speed of sound sensors, acoustic sensors, pressure sensors such as barometers and differential pressure sensors, accelerometers, gyroscopes, combination sensor devices such as inertial measurement units (IMUs), light detectors, light detection and ranging (LIDAR) units, radar units, cameras, other image sensors, and more), amplifiers, analog-to-digital converters (ADCs), digital-to-analog converters (DACs), and other digital logic components. For example, these low voltage components can, for example, have maximum voltage of 3.3 V, and have operating ranges from 0 V to 2.5 V. The low voltage components described herein can be susceptible to damage if a voltage is applied to the component exceeding the maximum operating voltage specification for the components (e.g., above 2 V, above 3 V, above 3.3 V, above 3.6 V, above 4 V, above 5 V, above 5.25 V, or above 5.5 V).

The present systems can utilize various TVS diodes and transistors (e.g., N-channel or P-channel MOSFETs), which is an advantage of the present systems over conventional transient protection solutions. In a conventional circuit utilizing a single TVS diode, the over voltage clamping rating of the TVS diode must be less than a maximum voltage that the downstream sensitive components can tolerate, while also ensuring that the signal of interest does not get clipped by the TVS diode itself. Using a MOSFET with the TVS diode as described herein introduces less filtering (or distortion) on the signal compared to conventional circuits using filters (e.g., RC low pass filters, ferrite bead filters, or choke filters), which allows higher bandwidths to be achieved as well as improved control of the voltage that passes through the present transient protection circuit during a transient event.

Standard TVS elements (e.g., TVS diodes, metal oxide varistors, avalanche diodes, spark gaps, or gas discharge tubes) and transistors (e.g., MOSFETs) can be used in the present transient protection circuits. For example, a MOSFET can be chosen with a required maximum voltage rating (i.e., at which no damage to the part occurs), on-state resistances (in both low and high resistance modes), and built-in gate capacitance. In some cases, the physical size of the MOSFET is proportional to the voltage rating of the part, and larger parts are needed to withstand larger voltages (although that is not always the case). The on-state resistance and the built-in gate capacitance of a MOSFET is also generally correlated to the physical size of the MOSFET. Generally, larger MOSFETs have smaller on-state resistances and greater built-in gate capacitances. Since larger MOSFETs can be required to withstand the voltages in the present transient protection circuits, the built-in gate to drain capacitance of the MOSFETs can cause undesirable parasitic effects in the efficacy of the present transient protection circuits. In order to compensate for the built-in gate to drain capacitance of the MOSFET, an additional external capacitance can be added to the circuit to counteract the built-in parasitic capacitances of the MOSFET, as described further below.

Examples of the present transient protection circuits throughout this disclosure often show a circuit utilizing a TVS diode and one or more MOSFETs. However, different types of TVS elements and transistors can be used in the present voltage transient protection circuits that utilize a TVS element and a downstream transistor. Some examples of TVS elements that can be used in the present circuits are TVS diodes, metal oxide varistor, an avalanche diode (e.g., a Zener diode), a spark gap, or a gas discharge tube. Some examples of transistors that can be used in the present circuits are FETs, such as MOSFETs (e.g., using silicon), FETs using SiC (silicon carbide), FETs using GaAs (gallium arsenide), or FETs using GaN (gallium nitride). Additionally, different sub-types of MOSFETs can be used such as enhancement-mode or depletion-mode MOSFETs, and N-channel and P-channel MOSFETs.

There are many applications of circuits with low voltage components that are susceptible to damage during a voltage transient event, and the present systems are not limited to be used in any particular system. The systems described herein are particularly advantageous for circuits with low voltage components, where the low voltage components are exposed to voltage transient events, and where the signal to those components benefit from low distortion. Some examples of applications for the present circuits are aerial vehicles, environmental monitoring systems, weather monitoring systems, utility telecommunications equipment, ground based defense equipment, and outdoor security systems (e.g., a building security system using sensors to detect intruders).

An example of a system that can benefit from the present voltage protection circuits are aerial vehicles. The terms “aerial vehicle” and “aircraft” are used interchangeably herein to refer to any type of vehicle capable of aerial movement, including, without limitation, High Altitude Platforms (HAPs), High Altitude Long Endurance (HALE) aircraft, unmanned aerial vehicles (UAVs), passive lighter than air vehicles (e.g., floating stratospheric balloons, other floating or wind-driven vehicles), powered lighter than air vehicles (e.g., balloons and airships with some propulsion capabilities), fixed-wing vehicles (e.g., drones, rigid kites, gliders), various types of satellites, and other high altitude aerial vehicles. Aerial vehicles typically contain low voltage components, such as actuators, sensors, microcontrollers, and communication components. Aerial vehicles are also particularly exposed to voltage transient events due to lightning. It is therefore advantageous to use the present transient voltage protection circuits to protect exposed low voltage components of an aerial vehicle wherein it is preferable not to physically shield said low voltage components, or wherein it is preferable to not to use heavy and bulky magnetic components (e.g., choke filters or ferrite bead filters), for example to reduce the cost and the weight of an aerial vehicle design and/or enable different physical designs and materials to be used to construct the aerial vehicle.

### Example Systems

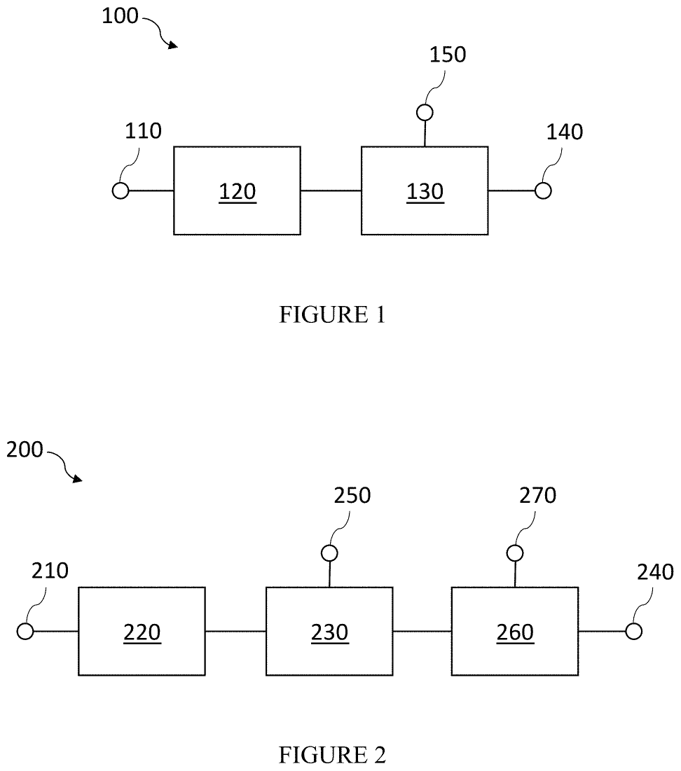

FIG. 1 is a simplified schematic diagram of an example of a transient voltage protection circuit 100, in accordance with some embodiments. Transient voltage protection circuit 100 contains an input 110, a TVS element 120 (e.g., TVS diode), a MOSFET 130, and a downstream node 140 (i.e., an output of the transient voltage protection circuit 100). The downstream node 140 contains low voltage components susceptible to damage if a voltage is applied to the node that exceeds the absolute maximum voltage specifications of components (e.g., above 2 V, above 3 V, above 3.3 V, above 3.6 V, above 4 V, above 5 V, above 5.25 V, or above 5.5 V). A gate voltage is applied to the MOSFET 130 using terminal 150. During routine operation (i.e., in the absence of a voltage transient event) a signal is applied to the input 110 to be transmitted to the node 140, and a bias is applied to terminal 150 to apply a gate voltage to the MOSFET 130 such that the MOSFET is in a low resistance on-state. In some embodiments, a signal can also be sent bi-directionally, from the input 110 to the node 140 and from the node 140 to the input 110. The low resistance of the MOSFET during routine operation will minimally filter or distort the signal between the input 110 and the node 140. During a voltage transient event, voltage transient (e.g., a medium to large voltage transient greater than 10 kV, or greater than 100 kV) is applied to the input 110, and the TVS element 120 absorbs a majority of the surge energy. Excess energy that does not get absorbed by the TVS element 120 and is transmitted past the TVS element 120 enters the MOSFET 130 at the drain. The excess voltage applied to the drain of the MOSFET 130 by the transient event causes the MOSFET 130 to switch to a high resistance linear mode, which further absorbs the energy of the transient voltage event. The selection of the MOSFET 130 and the gate voltage applied enables the voltage transmitted to the low voltage node 140 to stay below a critical voltage level, thereby protecting low voltage components of the node 140 during the voltage transient event.

In some embodiments, a positive signal and a positive or negative voltage transient is applied at node 110 and MOSFET 130 is an N-channel MOSFET. For example, in cases where the voltage transient is positive, a unidirectional TVS diode can be used as the TVS element 120 with a polarity such that the TVS diode maximum clamping voltage will be transmitted past the TVS element 120. For the same circuit, if the voltage transient is negative, then the forward voltage of the TVS diode will be transmitted past the TVS element 120. The forward voltage of a TVS diode can have a magnitude of approximately 1 V, which may be non-damaging to downstream components.

In other embodiments, a negative signal and a negative or positive voltage transient is applied at node 110 and MOSFET 130 is a P-channel MOSFET. For example, in cases where the voltage transient is negative, a unidirectional TVS diode can be used as the TVS element 120 with a polarity such that the TVS diode maximum clamping voltage will be transmitted past the TVS element 120. For the same circuit, if the voltage transient is positive, then the forward voltage of the TVS diode will be transmitted past the TVS element 120.

In other embodiments, the signal at the input is either positive or negative, or switches from positive to negative during routine operation, and the voltage transient at the input is either positive or negative. In such cases, two MOSFETs in series are used, as shown in FIG. 2. In such circuits with positive and negative (bipolar) signal usage, two MOSFETs 230 and 260 can be used in conjunction with a bidirectional TVS diode as the TVS element 220.

FIG. 2 is a simplified schematic diagram of an example of a transient voltage protection circuit 200, in accordance with some embodiments. Transient voltage protection circuit 200 contains an input 210, a bidirectional TVS element 220 (e.g., a bidirectional TVS diode), first MOSFET 230, a second MOSFET 260, and a downstream node 240 (i.e., an output of the transient voltage protection circuit 200). The first and second MOSFETs are an N-channel MOSFET and a P-channel MOSFET, and can be positioned with either the N-channel MOSFET or the P-channel MOSFET first. In other words, in some cases the first MOSFET is an N-channel MOSFET and the second MOSFET is a P-channel MOSFET, while in other cases, the first MOSFET is a P-channel MOSFET and the second MOSFET is an N-channel MOSFET. The downstream node 240 contains low voltage components susceptible to damage if a voltage present at node 240 exceeds a low level. A first gate voltage is applied to the first MOSFET 230 using terminal 250, and a second gate voltage is applied to the second MOSFET 260 using terminal 270. During routine operation a signal is applied to the input 210 to be transmitted to the node 240, and biases are applied to terminals 250 and 270 such that the MOSFETs 230 and 260 are both in low resistance on-states. During a voltage transient event, a voltage transient (e.g., greater than 10 V, greater than 10 kV, or greater than 100 kV) exceeding an absolute maximum specification is applied to the input 210, and the TVS element 220 absorbs a majority of the resulting surge energy. Excess energy that does not get absorbed by the TVS element 220 and is transmitted past the TVS element 220 first enters the drain of the first MOSFET 230 and any energy that is transmitted past the first MOSFET 230 enters the drain of the second MOSFET 260. The energy that is transmitted past the first MOSFET 230 enters the drain of the second MOSFET 260, where additional surge energy from the transient can be absorbed. In the case where the first MOSFET 230 is an N-channel MOSFET, the second MOSFET 260 is a P-channel MOSFET, and a positive transient voltage occurs, then the excess positive voltage applied to the drain of the N-channel MOSFET 230 by the transient event causes the N-channel MOSFET to switch to a high resistance linear mode, which further absorbs the energy of the transient voltage event. In the case of a negative transient voltage the excess negative voltage will pass through the N-channel MOSFET (i.e., the N-channel MOSFET will remain in a low resistance on-state) and will be applied to the drain of the P-channel MOSFET causing the P-channel MOSFET to switch to a high resistance linear mode, which further absorbs the energy of the transient voltage event. The selection of the N-channel and P-channel MOSFETs (230 and 260, or 260 and 230, respectively) and the gate voltages applied enables the voltage transmitted to the low voltage node 240 to stay below a critical voltage level, thereby protecting low voltage components of the node 240.

In some cases, the gate-to-source threshold voltage(s) of the MOSFET(s) in the present systems are chosen based on the desired on-state resistance of the MOSFET and the operating temperature, or the temperature profile, of the MOSFET(s). This can be beneficial since the MOSFET(s) will generally heat up as excess energy from the transient is absorbed in the MOSFET(s), and as the MOSFET(s) heat up the gate-to-source threshold voltage of the MOSFET(s) can change. Additionally, as the MOSFET(s) heat up the internal resistances of the MOSFET(s) can change, which can also affect the signal as it passes through the MOSFET(s), and therefore the characteristics of the MOSFET(s) used, the applied gate voltage(s), and other elements of the circuit (described further below) can also be selected to minimally filter and/or distort the signal as it passes through the MOSFET(s).

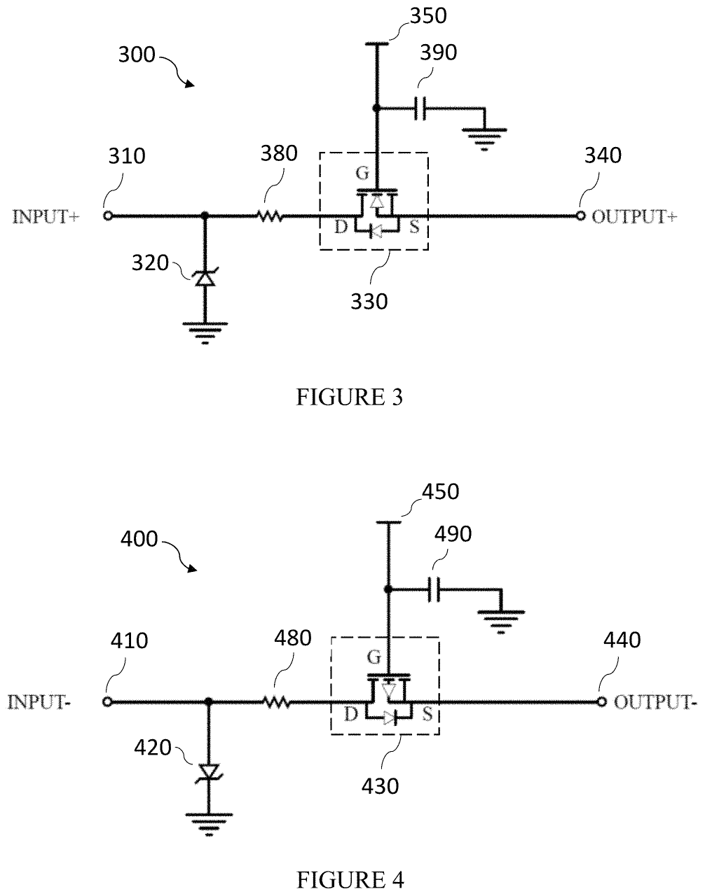

FIG. 3 is a circuit diagram showing an example of a transient voltage protection circuit 300 with a positive signal voltage, a positive or negative voltage transient, and an N-channel MOSFET 330. The transient voltage protection circuit 300 may function similarly to circuit 100 and may include the same or similar components. The transient voltage protection circuit 300 includes an input 310, a unidirectional TVS element 320 (e.g., a unidirectional TVS diode), an N-channel MOSFET 330, and a node 340 (i.e., an output of the transient voltage protection circuit 300). The downstream node 340 contains low voltage components susceptible to damage if a voltage is applied to the node exceeding an absolute maximum specification (e.g., above 2 V, above 3 V, above 3.3 V, above 3.6 V, above 4 V, above 5 V, above 5.25 V, or above 5.25 V).

A gate voltage is applied to the MOSFET 330 using terminal 350. Similar to the description above with reference to FIG. 1, during routine operation a signal is applied to the input 310 to be transmitted to the node 340, and a bias is applied to terminal 350 to apply a gate voltage to the MOSFET 330 such that the MOSFET is in a low resistance on-state. In some examples, the gate voltage applied to the N-channel MOSFET in the present systems is equal to the maximum signal voltage (i.e., the most positive voltage introduced to the input 310 during routine operation) added to the gate-to-source threshold voltage of the N-channel MOSFET. For example, where the node 340 comprises a low voltage component (e.g., a sensor, or other analog front end component of a circuit board) with a maximum voltage of 3.3 V, an operating range may be from 0 V to 2.5 V, and the gate-to-source threshold voltage may be approximately 2.5 V, resulting in a total gate bias voltage of approximately 5.0 V (i.e., 2.5 V maximum signal voltage +2.5 V gate-to-source threshold voltage). By applying the gate voltage to terminal 350, as described above, the N-channel MOSFET 330 will be in a low resistance on-state during routine operation and will clamp itself in a high resistance linear mode when a large voltage transient occurs. The selection of the MOSFET 330 and the applied gate voltage enables the voltage transmitted to the low voltage node 340 to stay below a critical voltage level, thereby protecting low voltage components of the node 340.

The TVS element 310 in this example is a TVS diode that has a first terminal connected to input 310, and a second terminal of the TVS element 310 is connected to ground. The unidirectional TVS element 310 is configured such that during a voltage transient event, when a large voltage transient (e.g., greater than 10 kV, or greater than 100 kV) is applied to the input 310, the TVS element 320 absorbs a majority of the surge energy by shunting the surge energy to ground. As discussed above, with respect to FIG. 1, when the voltage transient is positive, the TVS diode maximum clamping voltage will be transmitted past the TVS element 320. If the voltage transient is negative, then the forward voltage of the TVS diode will be transmitted past the TVS element 320. The MOSFET 330 is implemented downstream from the TVS element 320 (i.e., energy that is not absorbed by the TVS element and that is transmitted from the input 310 past the TVS element 320 enters the drain of the MOSFET 330), and therefore excess energy that does not get absorbed by the TVS element 320 and that is transmitted past the TVS element 320 (i.e., energy that is not absorbed by the TVS diode and that is not sent to ground through the TVS diode) is absorbed by the MOSFET 330 when the voltage transient causes the MOSFET 330 to switch into a high resistance linear mode.

The circuit 300 also contains a resistor 380 between the TVS element 320 and the MOSFET 330. In some embodiments, resistor 380 controls oscillations that the MOSFET 330 may exhibit during routine operation and/or during a voltage transient event.

The circuit 300 also contains a capacitor 390 between the terminal 350 and ground (i.e., on the gate of the MOSFET 330). The placement of capacitor 390 on the gate of the MOSFET 330 can counteract (or compensate for) the drain-gate parasitic capacitance of the MOSFET 330 itself. During a voltage transient event, the gate voltage variation of the MOSFET 330 due to the parasitic drain-gate capacitance will be inversely proportional to the added gate capacitance with respect to the parasitic drain-gate capacitance. Therefore, in some cases, the capacitor 390 on the gate of the MOSFET 330 has a greater than 10 times (or greater than 100 times) the parasitic drain-gate capacitance to keep the gate voltage on the MOSFET 330 constant. Keeping the gate voltage on the MOSFET 330 constant will keep the effective clamping voltage of the circuit (i.e., the voltage transmitted to the node 340) constant.

The external bias voltage at terminal 350 (applied to the gate of MOSFET 330) can be higher than the signal voltage (e.g., approximately one gate-to-source threshold voltage higher than the maximum signal amplitude) in order for the MOSFET 330 to operate as described above. Additional gate voltage greater than the sum of the maximum signal voltage and gate-to-source threshold voltage is also beneficial since it allows for more temperature variation of the MOSFET 330 as long as the absolute maximum voltage specifications for the components on the node 340 are not exceeded. Since the bias at terminal 350 is higher than the voltages applied to the low voltage node 340, the first power bus used for the node 340 may not be able to be used to bias the gate of the MOSFET 330. In some cases, the gate voltage at terminal 350 can be provided by a second higher voltage power bus (i.e., an alternate power rail, or an attenuated power rail) on the circuit (e.g., if the signal level is 3.3 V, then a second power bus with a voltage of 5 V may be available to bias the MOSFET). In other cases, a charge pump circuit (or a boost circuit, or an isolated power supply) can be used to build a higher voltage using the first power bus, and that higher voltage can be applied to the terminal 350 to bias the MOSFET 330. In some cases, the potential of the charge pump circuit (or boost circuit, or isolated power supply, or alternate power rail) may be too high for the gate voltage required, and the voltage can be attenuated before applying to terminal 350 to bias the MOSFET 330.

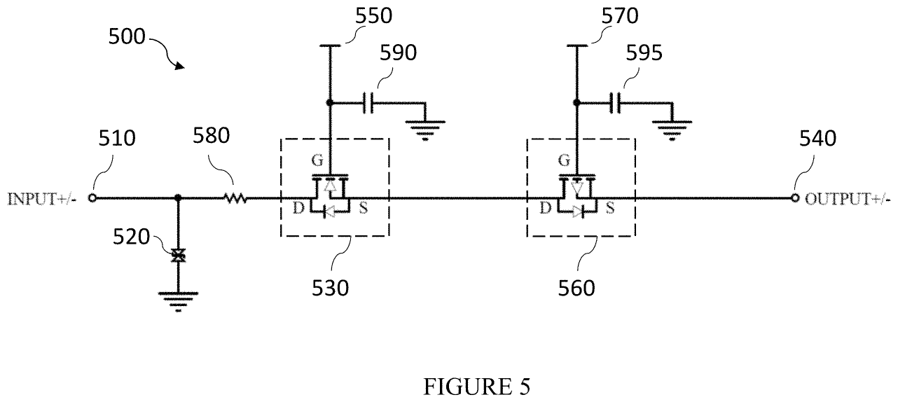

FIG. 4 is a circuit diagram showing an example of a transient voltage protection circuit 400 with a negative signal voltage, a negative or positive voltage transient, and a P-channel MOSFET 430. The components of circuit 400 have the same functions and are similar to the components in circuit 300 in FIG. 3. One difference between circuits 300 and 400 is that the MOSFET 430 in circuit 400 is a P-channel MOSFET 430 rather than an N-channel MOSFET (i.e., element 300 in FIG. 3). Circuit 400 also includes an input 410, a TVS element 420 (e.g., a TVS diode), and a node 440 (i.e., an output of the transient voltage protection circuit 300). The TVS element 420 is a unidirectional TVS diode in this example, and the direction of the TVS diode is opposite of that in the circuit in FIG. 3. In this case, when the voltage transient is negative, the TVS diode maximum clamping voltage will be transmitted past the TVS element 420. If the voltage transient is positive, then the forward voltage of the TVS diode will be transmitted past the TVS element 420. A gate voltage is applied to the MOSFET 430 using terminal 450. Resistor 480 and capacitor 490 in FIG. 4 perform similar functions as those described with respect to resistor 380 and capacitor 390 in FIG. 3, respectively.

The P-channel MOSFET 430 is biased similarly to the MOSFET 330 in FIG. 3 in order to operate in a low resistance mode during routine operation and clamp in a high resistance linear mode during a transient event. Similar to the description above with reference to FIGS. 1 and 3, during routine operation a signal is applied to the input 410 to be transmitted to the node 440, and a bias is applied to terminal 450 to apply a gate voltage to the MOSFET 430 such that the MOSFET is in a low resistance on-state. In some examples, the gate voltage applied to the P-channel MOSFET in the present systems is equal to the minimum signal voltage (i.e., the most negative voltage introduced to the input 410 during routine operation) minus (i.e., added to the negative of) the gate-to-source threshold voltage of the P-channel MOSFET 430. For example, where the node 440 comprises a low voltage device (e.g., a sensor, or other analog front end component of a circuit board) with a minimum voltage of −3.3 V, an operating range may be from −2.5 V to 0 V, and the gate-to-source threshold voltage may be approximately 2.5 V, resulting in a total gate bias voltage of approximately −5.0 V (i.e., −2.5 V maximum signal voltage −2.5 V gate-to-source threshold voltage). By applying the gate voltage to terminal 450, as described above, the P-channel MOSFET 430 will be in a low resistance on-state during routine operation and will clamp itself in a high resistance linear mode when a large voltage transient occurs. The selection of the MOSFET 430 and the applied gate voltage enables the voltage transmitted to the low voltage node 440 to stay below a critical voltage level, thereby protecting low voltage components of the node 440.

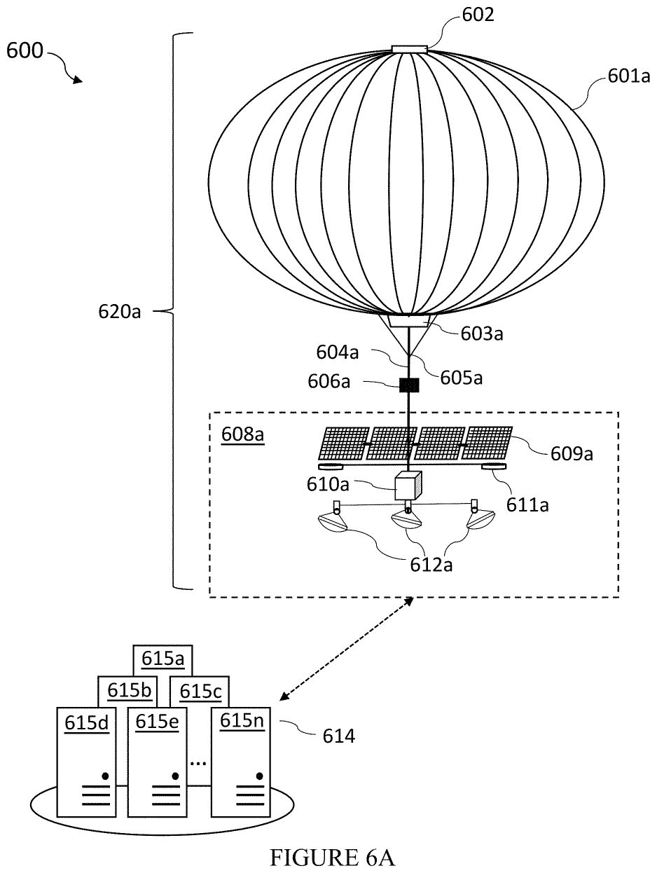

FIG. 5 is a circuit diagram showing an example of a transient voltage protection circuit 500 utilizing two MOSFETs configured in series, an N-channel MOSFET 530 and a P-channel MOSFET 560. Note that in other examples, the P-channel MOSFET can be positioned before the N-channel MOSFET in the circuit 500. Circuit 500 is similar to circuit 200 in FIG. 2, and also shares similar components and configurations described above with reference to FIGS. 3 and 4. In circuit 500, the signal at input 510 is either positive or negative, or switches from positive to negative during routine operation, and the voltage transient can be positive or negative. FIG. 5 contains an input 510, a bidirectional TVS element 520 (e.g., TVS diode), a first N-channel MOSFET 530, a second P-channel MOSFET 560, and a downstream node 540 (i.e., an output of the transient voltage protection circuit 500). The downstream node 540 contains low voltage components susceptible to damage if a voltage is applied to the node 540 above a low level. A first gate voltage is applied to the first N-channel MOSFET 530 using terminal 550, and a second gate voltage is applied to the second P-channel MOSFET 560 using terminal 570.

During routine operation a signal is applied to the input 510 to be transmitted to the node 540, and biases are applied to terminals 550 and 570 such that the first and second MOSFETs 530 and 560 are both in low resistance on-states. During a voltage transient event, a voltage transient (e.g., greater than 10 V, greater than 10 kV, or greater than 100 kV) exceeding an absolute maximum specification is applied to the input 510, and the bidirectional TVS element 520 absorbs a majority of the surge energy. Excess energy that does not get absorbed by the bidirectional TVS element 520 and is transmitted past the TVS element enters the drain of the N-channel MOSFET 530. Energy that is transmitted past the first N-channel MOSFET 530 enters the drain of P-channel MOSFET 560, where additional surge energy from the transient can be absorbed. In the case of a positive transient voltage, the excess positive voltage applied to the drain of the first N-channel MOSFET 530 by the transient event causes the N-channel MOSFET 530 to switch to a high resistance linear mode, which further absorbs the energy of the transient voltage event. In the case of a negative transient voltage the excess negative voltage will pass through the first N-channel MOSFET 530 (i.e., the first N-channel MOSFET 530 will remain in a low resistance on-state) and will be applied to the drain of the second P-channel MOSFET 560 causing the P-channel MOSFET 560 to switch to a high resistance linear mode, which further absorbs the energy of the transient voltage event. In other examples where the P-channel MOSFET is positioned before the N-channel MOSFET, a negative voltage transient will cause the P-channel MOSFET to switch into a high resistance mode, and a positive voltage transient will pass through the P-channel MOSFET (which will remain in a low resistance on-state) and cause the N-channel MOSFET to switch into a high resistance mode. The selection of the N-channel and P-channel MOSFETs (530 and 560, or 560 and 530, respectively) and the gate voltage applied enables the voltage transmitted to the low voltage node 540 to stay below a critical voltage level, thereby protecting low voltage components of the node 540.

Resistor 580 in FIG. 5 performs similar functions as those described with respect to resistor 380 in FIG. 3 and resistor 480 in FIG. 4. Capacitors 590 and 595 in FIG. 5 perform similar functions as those described with respect to capacitor 390 in FIG. 3 and capacitor 490 in FIG. 4, respectively.

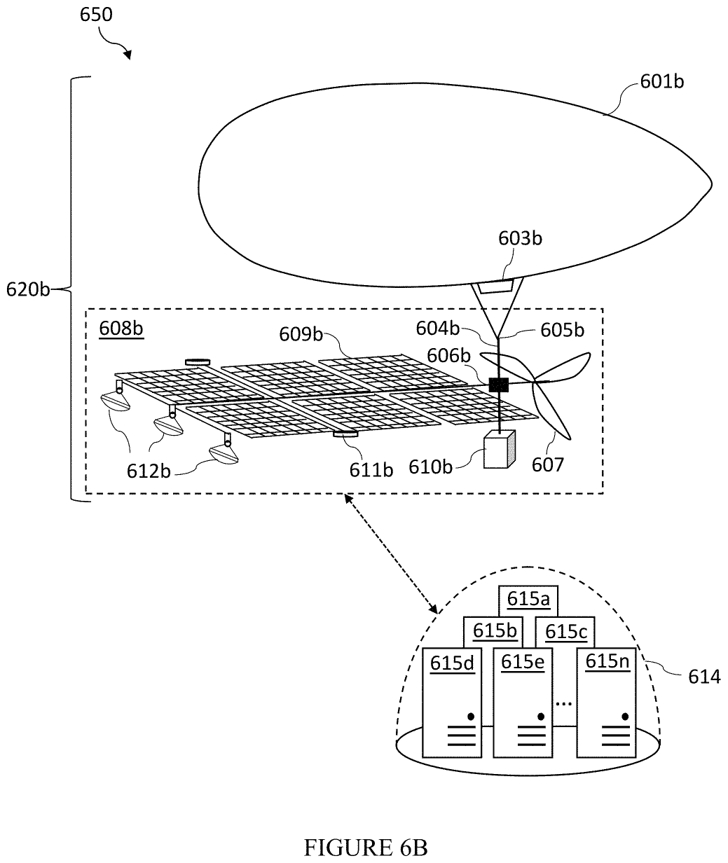

The transient voltage protection circuits described herein can be used in many applications that contain systems using low voltage electronics that are exposed to large voltage transient events. For example, systems that are exposed to being struck by lightning that use low voltage circuits which are not adequately shielded from the voltage transients can benefit from the present transient voltage protection circuits. FIGS. 6A, 6B, 7 and 8 show some example systems incorporating the present transient voltage protection circuits for illustrative purposes.

FIGS. 6A-6B are diagrams of example aerial vehicle systems incorporating the present transient voltage protection circuits, in accordance with some embodiments. The UAVs 620a-b shown in FIGS. 6A-6B, and described further below, contain low voltage electronics (e.g., actuators, sensors, microcontrollers, communication components, etc.) that may be exposed to transients from lightning or other electrical storm activity. Therefore, a transient voltage protection circuit (e.g., those described in FIGS. 1-5) can be incorporated into the circuitry within the UAVs 620a-b to protect low voltage components. An advantage of using the present transient voltage protection circuits in a UAV like UAV 620a or 620b compared to conventional transient voltage protection solutions using physical shielding, or heavy components (e.g., choke filters or ferrite bead filters), is that the cost and the weight of such UAVs can be reduced, and different physical designs and materials can be used to construct the UAVs.

In FIG. 6A, there is shown a diagram of system 600 for navigation of aerial vehicle 620a. In some examples, aerial vehicle 620a may be a passive vehicle, such as a balloon or satellite, wherein most of its directional movement is a result of environmental forces, such as wind and gravity. In other examples, aerial vehicles 620a may be actively propelled. In an embodiment, system 600 may include aerial vehicle 620a and ground station 614. In this embodiment, aerial vehicle 620a may include balloon 601a, plate 602, altitude control system (ACS) 603a, connection 604a, joint 605a, actuation module 606a, and payload 608a. In some examples, plate 602 may provide structural and electrical connections and infrastructure. Plate 602 may be positioned at the apex of balloon 601a and may serve to couple together various parts of balloon 601a. In other examples, plate 602 also may include a flight termination unit, such as one or more blades and an actuator to selectively cut a portion and/or a layer of balloon 601a. ACS 603a may include structural and electrical connections and infrastructure, including components (e.g., fans, valves, actuators, etc.) used to, for example, add and remove air from balloon 601a (i.e., in some examples, balloon 601a may include an interior ballonet within its outer, more rigid shell that is inflated and deflated), causing balloon 601a to ascend or descend, for example, to catch stratospheric winds to move in a desired direction. Balloon 601a may comprise a balloon envelope comprised of lightweight and/or flexible latex or rubber materials (e.g., polyethylene, polyethylene terephthalate, chloroprene), tendons (e.g., attached at one end to plate 602 and at another end to ACS 603a) to provide strength to the balloon structure, a ballonet, along with other structural components. In various embodiments, balloon 601a may be non-rigid, semi-rigid, or rigid.

Connection 604a may structurally, electrically, and communicatively, connect balloon 601a and/or ACS 603a to various components comprising payload 608a. In some examples, connection 604a may provide two-way communication and electrical connections, and even two-way power connections. Connection 604a may include a joint 605a, configured to allow the portion above joint 605a to pivot about one or more axes (e.g., allowing either balloon 601a or payload 608a to tilt and turn). Actuation module 606a may provide a means to actively turn payload 608a for various purposes, such as improved aerodynamics, facing or tilting solar panel(s) 609a advantageously, directing payload 608a and propulsion units (e.g., propellers 607 in FIG. 6B) for propelled flight, or directing components of payload 608a advantageously.

Payload 608a may include solar panel(s) 609a, avionics chassis 610a, broadband communications unit(s) 611a, and terminal(s) 612a. Solar panel(s) 609a may be configured to capture solar energy to be provided to a battery or other energy storage unit, for example, housed within avionics chassis 610a. Avionics chassis 610a also may house a flight computer (e.g., to electronically control various systems within the UAV 620a), a transponder, along with other control and communications infrastructure (e.g., a computing device and/or logic circuit configured to control aerial vehicle 620a). Communications unit(s) 611a may include hardware to provide wireless network access (e.g., LTE, fixed wireless broadband via 5G, Internet of Things (IoT) network, free space optical network or other broadband networks). Terminal(s) 612a may comprise one or more parabolic reflectors (e.g., dishes) coupled to an antenna and a gimbal or pivot mechanism (e.g., including an actuator comprising a motor). Terminal(s) 612(a) may be configured to receive or transmit radio waves to beam data long distances (e.g., using the millimeter wave spectrum or higher frequency radio signals). In some examples, terminal(s) 612a may have very high bandwidth capabilities. Terminal(s) 612a also may be configured to have a large range of pivot motion for precise pointing performance. Terminal(s) 612a also may be made of lightweight materials.

In other examples, payload 608a may include fewer or more components, including propellers 607 as shown in FIG. 6B, which may be configured to propel aerial vehicles 620a-b in a given direction. In still other examples, payload 608a may include still other components well known in the art to be beneficial to flight capabilities of an aerial vehicle. For example, payload 608a also may include energy capturing units apart from solar panel(s) 609a (e.g., rotors or other blades (not shown) configured to be spun by wind to generate energy). In another example, payload 608a may further include or be coupled to an imaging device (e.g., a star tracker, IR, video, Lidar, and other imaging devices, for example, to provide image-related state data of a balloon envelope, airship hull, and other parts of an aerial vehicle). In another example, payload 608a also may include various sensors (not shown), for example, housed within avionics chassis 610a or otherwise coupled to connection 604a or balloon 601a. Such sensors may include Global Positioning System (GPS) sensors, wind speed and direction sensors such as wind vanes and anemometers, temperature sensors such as thermometers and resistance temperature detectors, speed of sound sensors, acoustic sensors, pressure sensors such as barometers and differential pressure sensors, accelerometers, gyroscopes, combination sensor devices such as inertial measurement units (IMUs), light detectors, light detection and ranging (LIDAR) units, radar units, cameras, other image sensors, and more. These examples of sensors are not intended to be limiting, and those skilled in the art will appreciate that other sensors or combinations of sensors in addition to these described may be included without departing from the scope of the present disclosure.

Ground station 614 may include one or more server computing devices 615a-n, which in turn may comprise one or more computing devices (e.g., a computing device and/or logic circuit configured to control aerial vehicle 620a). In some examples, ground station 614 also may include one or more storage systems, either housed within server computing devices 615a-n, or separately. Ground station 614 may be a datacenter servicing various nodes of one or more networks.

FIG. 6B shows a diagram of system 650 for navigation of aerial vehicle 620b. All like-numbered elements in FIG. 6B are the same or similar to their corresponding elements in FIG. 6A, as described above (e.g., balloon 601a and balloon 601b may serve the same function, and may operate the same as, or similar to, each other). In some examples, balloon 601b may comprise an airship hull or dirigible balloon. In this embodiment, aerial vehicle 620b further includes, as part of payload 608b, propellers 607, which may be configured to actively propel aerial vehicle 620b in a desired direction, either with or against a wind force to speed up, slow down, or re-direct, aerial vehicle 620b. In this embodiment, balloon 601b also may be shaped differently from balloon 601a, to provide different aerodynamic properties.

As shown in FIGS. 6A-6B, aerial vehicles 620a-b may be largely wind-influenced aerial vehicle, for example, balloons carrying a payload (with or without propulsion capabilities) as shown, or fixed wing high altitude drones (not shown) with gliding and/or full propulsion capabilities. However, those skilled in the art will recognize that the systems disclosed herein may similarly apply and be usable by various other types of aerial vehicles.

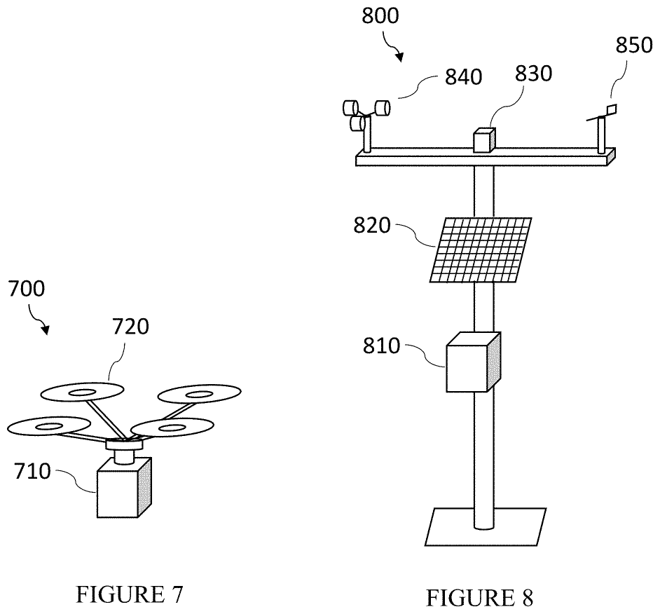

In some cases, an aerial vehicle using a transient protection circuit, as described herein, does not include a balloon and the required lift is provided by other means. For example, aerial vehicles with propellers, high altitude aerial vehicles with propellers, and/or gliders with no propellers can all benefit from the present systems. FIG. 7 shows a simplified schematic of an example of an unmanned aerial vehicle (UAV) 700 incorporating the present transient voltage protection circuits, in accordance with some embodiments. The UAV 700 depicts a UAV containing an electronics module 710 and four propellers 720 that provide lift. In other UAV examples, there can be more or fewer than four propellers. The UAV 700 can also contain sensors (not shown), such as temperature sensors, barometric pressure sensors, wind speed sensors, wind direction sensors, global positioning system (GPS) components, and image sensors. In addition to the sensors, the electronics module 710 also can contain low voltage electronic components, such as a DAC or an ADC, a microprocessor and communication electronics, in order to communicate with a remote control or other system (not shown) that controls the UAV 700, and optionally to interpret the data from the sensors. The UAV 700 also may be exposed to transients caused by lightning or other electrical storm activity, and therefore a transient voltage protection circuit (e.g., the circuits described in FIGS. 1-5) can be incorporated into the circuitry within the electronics module 710 to protect the low voltage electronic components therein. An advantage of using the present transient voltage protection circuits in an aerial vehicle (e.g., like UAV 700) compared to conventional transient voltage protection solutions using physical shielding, or heavy components (e.g., choke filters or ferrite bead filters), is that the cost and the weight of such aerial vehicles can be reduced, and different physical designs and materials can be used to construct the aerial vehicles.

The present transient protection circuits can also be used in systems other than those of aerial vehicles. There are many systems which are not part of an aerial vehicle, that incorporate low voltage electronics, and that are exposed to large voltage transients (e.g., from lightning strikes, ESD, or other injected or induced voltage transients). Some examples of systems with low voltage components (e.g., sensors) that are exposed to being struck by lighting include environmental monitoring systems or weather monitoring systems used for agricultural or other applications, utility telecommunications equipment, ground based defense equipment, and security systems using outdoor cameras and/or motion sensors to detect intruders or for other applications.

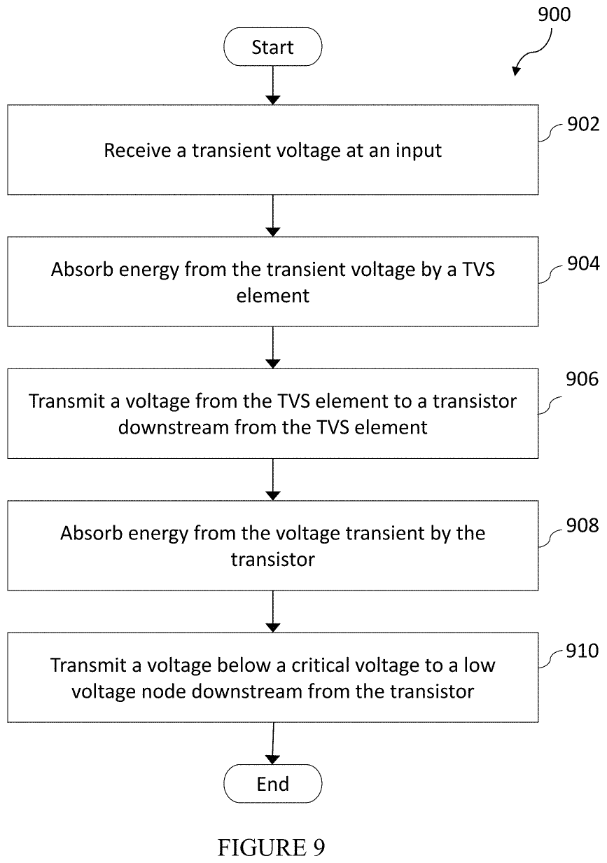

FIG. 8 shows a simplified schematic of an example of an environmental monitoring system 800 incorporating a transient voltage protection circuit, as described herein, in accordance with some embodiments. The system 800 depicts a weather monitoring system that can be free-standing (e.g., in an agricultural field, or other location) or mounted to an existing structure (e.g., a building, a utility pole, or a water tower). The system 800 contains an electronics module 810, a power source 820 (shown in this example as a solar panel that captures energy from the sun and optionally charges a battery, however, in other examples the power source 820 can be a battery or other energy source instead of a solar panel), and sensors 830, 840 and 850. The sensors in the system 800 are shown as a temperature and/or barometric pressure sensor 830, a wind speed sensor 840, and a wind direction sensor 850. In other environmental monitoring systems the sensors could be the same or different as the sensors 830, 840 and 850 shown in system 800. The electronics module 810 contains low voltage electronic components, such as a DAC or an ADC, a microprocessor and communication electronics, in order to interpret the data from the sensors 830, 840 and 850, and optionally communicate that data to another system (not shown). The system 800 may be exposed to transients from lightning or other electrical storm activity, and therefore a transient voltage protection circuit (e.g., the circuits described in FIGS. 1-5) can be incorporated (e.g., into the circuitry within the electronics module 810) to protect the low voltage electronic components of the system. An advantage of using the present transient voltage protection circuits in a system like system 800 is that the physical shielding requirements for the low voltage components can be relaxed, which can reduce the cost of such systems and enable different physical designs and materials to be used to construct the system.

### Example Methods

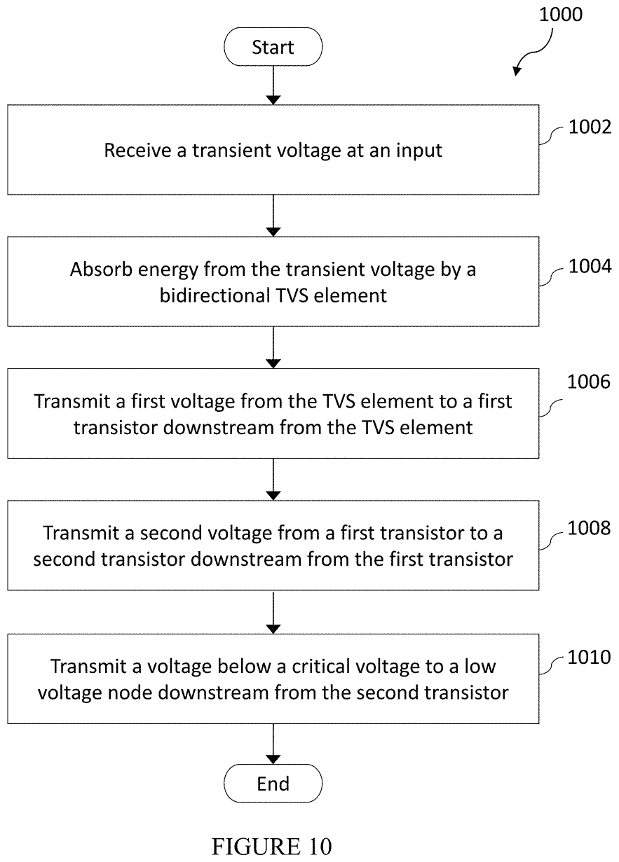

In some embodiments, a method 900 of protecting low voltage components from a transient voltage event includes the steps shown in FIG. 9. Method 900 begins with receiving a transient voltage at an input of a transient voltage protection circuit (e.g., as shown in any of FIGS. 1-5) at step 902. At step 904, energy from the transient voltage is absorbed by a TVS element (e.g., a TVS diode, metal oxide varistor, an avalanche diode (e.g., a Zener diode), a spark gap, or a gas discharge tube). At step 906, a voltage is transmitted to a transistor (e.g., a MOSFET, or other type of FET) downstream from the TVS element. For example, if the TVS element is a TVS diode, then the voltage transmitted to the transistor will be approximately equal to the maximum clamping voltage of the TVS diode. At step 908, the transistor absorbs energy from the transient voltage (i.e., energy that was not absorbed by the TVS element). At step 910, a voltage below a critical voltage is transmitted to a low voltage node that is downstream from the transistor.

In method 900, similar to the systems described above (e.g., in FIGS. 1-5) a gate bias can be applied to the transistor such that it is in a low resistance on-state during routine operation and clamps in a high resistance linear mode when exposed to higher voltages during a voltage transient event. In some embodiments of method 900, a majority of the energy of the energy surge is absorbed by the TVS element, and energy of the surge that is not absorbed by the TVS element and that is transmitted past the TVS element enters the transistor and is absorbed by the transistor. As a result of method 900, a low voltage is transmitted to the downstream node containing low voltage component(s), and the low voltage components are protected from damage during the voltage transient event.

In some embodiments, a method 1000 of protecting low voltage components from a transient voltage event includes the steps shown in FIG. 10. Method 1000 begins with receiving a transient voltage at an input of a transient voltage protection circuit (e.g., as shown in any of FIGS. 1-5) at step 1002. At step 1004, energy from the transient voltage is absorbed by a bidirectional TVS element (e.g., a TVS diode, metal oxide varistor, an avalanche diode (e.g., a Zener diode), a spark gap, or a gas discharge tube). At step 1006, a first voltage is transmitted to a first transistor (e.g., an N-channel MOSFET) downstream from the TVS element. For example, if the bidirectional TVS element is a bidirectional TVS diode, then the first voltage transmitted to the first transistor will be approximately equal to the maximum clamping voltage of the TVS diode. At step 1008, a second voltage is transmitted to a second transistor (e.g., a P-channel MOSFET) downstream from the first transistor. At step 1010, a voltage below a critical voltage is transmitted to a low voltage node that is downstream from the second transistor.

In some embodiments, the method 1000 employs two transistors so that a positive or negative signal voltage and a positive or negative transient voltage can be accommodated by the transient voltage protection circuit. For example, if the voltage transient at the input of the circuit is positive, the first transistor is an N-channel MOSFET, and the second transistor is a P-channel MOSFET, then the N-channel MOSFET can be biased such that it absorbs energy from the transient voltage, and the second voltage transmitted to the P-channel MOSFET is a low voltage. In that case, the P-channel MOSFET can be biased to remain in the low resistance on-state and simply transmit the low voltage to the low voltage node. Alternatively, if the voltage transient at the input of the circuit is negative, the first transistor is an N-channel MOSFET, and the second transistor is a P-channel MOSFET, then the N-channel MOSFET can be biased such that it remains in a low resistance on-state and transmits the first voltage to the P-channel MOSFET. In that case, the P-channel MOSFET can be biased such that it absorbs energy from the transient voltage, and then transmits the low voltage to the low voltage node.

In method 1000, similar to the systems described above (e.g., in FIGS. 1-5) a first and a second gate bias can be applied to the first and the second transistors, respectively, such that they are both in a low resistance on-state during routine operation and both can clamp in a high resistance linear mode when exposed to higher voltages of a particular polarity during a voltage transient event. In some embodiments of method 1000, a majority of the energy of the energy surge is absorbed by the bidirectional TVS element, and energy of the surge that is not absorbed by the bidirectional TVS element and that is transmitted past the bidirectional TVS element is absorbed by either the first or the second transistor. As a result of method 1000, a low voltage is transmitted to the downstream node containing low voltage component(s), and the low voltage components are protected from damage during the voltage transient event.

While specific examples have been provided above, it is understood that the present invention can be applied with a wide variety of inputs, thresholds, ranges, and other factors, depending on the application. For example, the time frames and ranges provided above are illustrative, but one of ordinary skill in the art would understand that these time frames and ranges may be varied or even be dynamic and variable, depending on the implementation.

As those skilled in the art will understand, a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements.

What is claimed is:

1. A transient voltage protection circuit, comprising:
an input, wherein a transient voltage event causes a transient voltage at the input;
a transient voltage suppression (TVS) diode implemented downstream from the input, wherein the TVS diode is configured to absorb energy of the transient voltage event; and
a metal-oxide-semiconductor field-effect transistor (MOSFET) implemented downstream from the TVS diode;
wherein:
a gate voltage applied to the MOSFET is based on a desired on-state resistance of the MOSFET in the absence of the transient voltage;
energy of the transient voltage event that is not absorbed by the TVS diode and that is transmitted past the TVS diode enters a drain of the MOSFET; and
the MOSFET is configured to clamp in a linear mode in response to the transient voltage event.

2. The transient voltage protection circuit of claim 1, wherein:
a positive signal voltage is applied at the input, wherein the transient voltage is larger than a maximum positive signal voltage;
the metal-oxide-semiconductor field-effect transistor (MOSFET) is an N-channel MOSFET; and
the gate voltage is the sum of the maximum positive signal voltage and a gate-to-source threshold voltage of the N-channel MOSFET.

3. The transient voltage protection circuit of claim 1, wherein:
a negative signal voltage is applied at the input, wherein the transient voltage is smaller than a minimum negative signal voltage;
the metal-oxide-semiconductor field-effect transistor (MOSFET) is a P-channel MOSFET; and
the gate voltage is the minimum negative signal voltage minus a gate-to-source threshold voltage of the P-channel MOSFET.

4. The transient voltage protection circuit of claim 1, further comprising a resistor located between the transient voltage suppression diode and the metal-oxide-semiconductor field-effect transistor (MOSFET).

5. The transient voltage protection circuit of claim 1, further comprising a capacitor connected to the gate of the metal-oxide-semiconductor field-effect transistor (MOSFET) to counteract a drain-gate parasitic capacitance of the MOSFET.

6. The transient voltage protection circuit of claim 1, further comprising a low voltage node downstream from the metal-oxide-semiconductor field-effect transistor (MOSFET), wherein a component of the low voltage node is susceptible to failure if exposed to a maximum clamping voltage of the transient voltage suppression diode.

7. The transient voltage protection circuit of claim 6, wherein the low voltage node comprises a low voltage component selected from the group consisting of an amplifier, an analog to digital converter, a digital to analog converter, a component in an analog front end of a circuit board, a digital logic component, a resistive temperature device, or a sensor.

8. The transient voltage protection circuit of claim 6, wherein a voltage transmitted to the low voltage node is below a critical voltage level.

9. The transient voltage protection circuit of claim 6, wherein the low voltage node is susceptible to failure if a voltage greater than 3.6 V is applied to the low voltage node.

10. The transient voltage protection circuit of claim 1, further comprising a charge pump circuit, a voltage boost circuit, an isolated power supply, an alternate power rail, or an attenuated power rail, that is used to apply the gate voltage.

11. The transient voltage protection circuit of claim 1, wherein the gate voltage applied to the metal-oxide-semiconductor field-effect transistor (MOSFET) is further based on a temperature profile of the MOSFET.

12. The transient voltage protection circuit of claim 1, wherein the transient voltage event is caused by lightning or electrostatic discharge.

13. An aerial vehicle comprising the transient voltage protection circuit of claim 1.

14. The circuit of claim 1, further comprising a low voltage node comprising a component of an aerial vehicle.

15. A transient voltage protection circuit, comprising:
an input, wherein a transient voltage event causes a transient voltage at the input;
a transient voltage suppression (TVS) diode implemented downstream from the input, wherein the TVS diode is configured to absorb energy in the transient voltage event;
a first metal-oxide-semiconductor field-effect transistor (MOSFET) implemented downstream from the TVS diode, wherein:
a first gate voltage applied to the first MOSFET is based on a desired on-state resistance of the first MOSFET in the absence of the transient voltage; and
energy of the transient voltage event that is not absorbed by the TVS diode and that is transmitted past the TVS diode enters a drain of the first MOSFET; and
a second MOSFET implemented downstream from the first MOSFET, wherein:
a second gate voltage applied to the second MOSFET is based on a desired on-state resistance of the second MOSFET in the absence of the transient voltage; and
energy of the transient voltage event that is not absorbed by the TVS diode or by the first MOSFET and that is transmitted past the first MOSFET enters a drain of the second MOSFET.

16. The transient voltage protection circuit of claim 15, wherein:
the first metal-oxide-semiconductor field-effect transistor (MOSFET) is an N-channel MOSFET configured to clamp in a linear mode in response to a positive transient voltage; and
the second MOSFET is a P-channel MOSFET configured to clamp in a linear mode in response to a negative transient voltage.

17. The transient voltage protection circuit of claim 16, wherein:
the transient voltage is larger than a maximum positive signal voltage; and
the first gate voltage is the sum of the maximum positive signal voltage and a first gate-to-source threshold voltage of the first metal-oxide-semiconductor field-effect transistor (MOSFET).

18. The transient voltage protection circuit of claim 15, wherein:
the first metal-oxide-semiconductor field-effect transistor (MOSFET) is a P-channel MOSFET configured to clamp in a linear mode in response to a negative transient voltage; and
the second MOSFET is an N-channel MOSFET configured to clamp in a linear mode in response to a positive transient voltage.

19. The transient voltage protection circuit of claim 18, wherein:
the transient voltage is smaller than a minimum negative signal voltage; and
the first gate voltage is the minimum negative signal voltage minus a first gate-to-source threshold voltage of the first metal-oxide-semiconductor field-effect transistor (MOSFET).

20. The transient voltage protection circuit of claim 15, further comprising a resistor placed between the transient voltage suppression diode and the first metal-oxide-semiconductor field-effect transistor (MOSFET).

21. The transient voltage protection circuit of claim 15, further comprising:
a first capacitor connected to a gate of the first metal-oxide-semiconductor field-effect transistor (MOSFET) to counteract a first drain-gate parasitic capacitance of the first MOSFET; and
a second capacitor connected to a gate of the second MOSFET to counteract a second drain-gate parasitic capacitance of the second MOSFET.

22. The transient voltage protection circuit of claim 15, further comprising a low voltage node downstream from the second metal-oxide-semiconductor field-effect transistor (MOSFET), wherein the low voltage node is susceptible to failure if exposed to a maximum clamping voltage of the transient voltage suppression diode.

23. The transient voltage protection circuit of claim 22, wherein the low voltage node comprises a low voltage component selected from the group consisting of an amplifier, an analog to digital converter, a digital to analog converter, a component in an analog front end of a circuit board, a digital logic component, a resistive temperature device, or a sensor.

24. The transient voltage protection circuit of claim 22, wherein a voltage transmitted to the low voltage node is below a critical voltage level.

25. The transient voltage protection circuit of claim 22, wherein the low voltage node is susceptible to failure if a voltage greater than 3.6 V is applied to the low voltage node.

26. The transient voltage protection circuit of claim 15, further comprising a charge pump circuit, a voltage boost circuit, an isolated power supply, an alternate power rail, or an attenuated power rail, that is used to apply the first gate voltage and the second gate voltage.

27. The transient voltage protection circuit of claim 15, wherein:
the first gate voltage applied to the first metal-oxide-semiconductor field-effect transistor (MOSFET) is further based on a temperature profile of the first MOSFET; and
the second gate voltage applied to the second MOSFET is further based on a temperature profile of the second MOSFET.

28. The transient voltage protection circuit of claim 15, wherein the transient voltage event is caused by lightning or electrostatic discharge.

29. An aerial vehicle comprising the transient voltage protection circuit of claim 15.

30. The circuit of claim 15, further comprising a low voltage node comprising a component of an aerial vehicle.
